(19) United States
(12) Patent Application Publication
(10) Pub. No.: US 2020/0247229 A1
(43) Pub. Date: Aug. 6, 2020

(54) Hybrid Drive Module for a Motor Vehicle

(71) Applicant: ZF Friedrichshafen AG, Friedrichshafen (DE)

(72) Inventors: Thomas Riedisser, Sigmarszell (DE); Robert Reiser, Nenzingen (DE); Gerald Viernekes, Hassfurt (DE); Jürgen Dacho, Bad Kissingen (DE); Thomas Bauer, Gro?bardorf (DE); Monika Rössner, Donnersdorf (DE); Stephan Stroph, Tettnang (DE); Linus Eschenbeck, Wangen (DE); Christopher Allnoch, Kressbronn (DE); Erwin Wack, Niederwerrn (DE); Mario Kensy, Hammelburg (DE); Peter Frey, Gerolzhofen (DE); Christian Wickel, Wartmannsroth (DE); Michael Wirachowski, Würzburg (DE)

(21) Appl. No.: 16/757,103

(22) PCT Filed: Sep. 6, 2018
(86) PCT No.: PCT/EP2018/073946

§ 371 Date: Apr. 17, 2020

(30) Foreign Application Priority Data
Oct. 19, 2017 (DE) 10 2017 218 744.1

(51) Int. Cl. B60K 6/38; B60K 6/26; F02B 61/06; B60K 6/24; B60K 6/36; F16H 45/02; F16H 41/24; F16D 3/12; F16F 15/123

(52) U.S. Cl. CPC B60K 6/38; B60K 6/26; F02B 61/06; B60K 6/24; B60K 6/36; B60Y 2200/92; F16H 41/24; F16D 3/12; F16F 15/123; F16H 2045/0231; F16H 2045/0263; F16H 45/02

(57) ABSTRACT

A hybrid drive module (1) for a motor vehicle includes a housing (GG), a torque converter (TC), and an electric machine with a rotor (R) and a stator (S). The rotor (R) is arranged on a rotor carrier (RT), which is fixedly connected to a hub (N). The hub (N) is rotatably supported via at least one first bearing (L1) and is supported in radial and axial directions against a bearing shield (LS). The hub (N) is rotationally fixed to a converter housing (TCH) of the torque converter (TC) via a rivet joint (RI) or a screw connection. A drive train for a motor vehicle including such a hybrid drive module (1) is also provided.

### CROSS-REFERENCE TO RELATED APPLICATION

The present application is related and has right of priority to German Patent Application No. 10 2017 218 744.1 filed on Oct. 19, 2017 and to PCT International Publication No. 2019/076530, both of which are incorporated by reference in their entirety for all purposes.

### FIELD OF THE INVENTION

The invention relates generally to a hybrid drive module for a motor vehicle. The hybrid drive module can be an integral part of a motor vehicle automatic transmission, or can be designed as an independent unit including at least one interface to a motor vehicle automatic transmission. The invention further relates generally to a drive train for a motor vehicle including such a hybrid drive module.

### BACKGROUND

U.S. Pat. No. 6,777,837 B2 describes a hybrid drive unit, which includes an electric machine and a torque converter within a housing. A rotor of the electric machine is rotatably supported on a bearing shield with an antifriction bearing. The rotor is rotationally fixed to a central part via a spline. The central part is connected to a front cover of the torque converter with a welded joint. In a design of this type, it is not ensured that the electric machine and the torque converter have the same axis of rotation. As a result, undesirable vibrations can occur in the motor vehicle drive train.

U.S. Pat. No. 6,478,101 B1 also describes a hybrid drive unit including an electric machine and a torque converter within a housing. A rotor of the electric machine is supported via a centering seat in the crankshaft of an internal combustion engine, to which the hybrid drive unit is connectable. The rotor is attached via a screw connection to weld nuts, which are attached to a front cover of the torque converter. The centering seat is convex, in order to reduce the transmission of torsional vibrations from the internal combustion engine to the rotor. This allows for a tilting movement between the rotor and the stator of the electric machine, however, whereby undesirable vibrations can occur in the motor vehicle drive train.

DE 10 2006 034 945 A1 describes a drive arrangement for a hybrid vehicle, which includes an electric machine and a torque converter. A rotor of the electric machine is connected to a hub, which is connected to a clutch output shaft, which is connected via a spline to a converter housing of the torque converter. Due to the spline, a slanted position of the torque converter in relation to the rotor can occur. Due to the imbalance arising as a result, undesirable vibrations can occur in the motor vehicle drive train.

### SUMMARY OF THE INVENTION

Example aspects of the invention provide a hybrid drive module, which allows for a preferably precise mounting and centering of the rotor and the torque converter, in order to prevent an excitation of vibrations.

A hybrid drive module for a motor vehicle is provided, which includes a housing, an electric machine, and a torque converter. The electric machine includes a rotary rotor and a stator, which is rotationally fixed with respect to the housing. The rotor is arranged on a rotor carrier, which is rotationally fixed to a hub. The hub is rotatably supported via at least one first bearing, and is supported in the radial and axial directions via this first bearing. The first bearing is supported against a bearing shield attached to the housing.

According to example aspects of the invention, the hub is rotationally fixed to a converter housing of the torque converter via a rivet joint or a screw connection. In other words, the converter housing and the rotor carrier are fixedly connected to the hub, whereby an identical axis of rotation of the rotor and the torque converter is ensured. Due to the radial and axial support of the hub against the bearing shield, a precise mounting of the rotor as well as of the converter housing is achieved.

Preferably, the hub includes a torque-transmitting interface to a secondary side of a torsional vibration damper. A primary side of the torsional vibration damper is connectable, in a torque-transmitting manner, to a crankshaft of an internal combustion engine, for example, via a flange joint. If necessary, an intermediate element can be arranged between the primary side of the torsional vibration damper and the crankshaft. The internal combustion engine itself is not an integral part of the hybrid drive module. Due to the torsional vibration damper, a radial offset between the axis of rotation of the crankshaft and the axis of rotation of the composite of hub, converter housing, and rotor carrier can be compensated for. As a result, a determination of the axes of rotation of the crankshaft and the aforementioned composite by redundant features can be avoided. In addition, the torsional vibration damper reduces the torsional vibration load, which acts upon the connection between the hub and the converter housing as well as between the hub and the rotor carrier.

The torque-transmitting interface of the hub to the secondary side of the torsional vibration damper is preferably designed as a spline, which is arranged in a dry space of the hybrid drive module. The dry space can be protected against environmental influences by forming a composite of hybrid drive module and internal combustion engine. Due to the connection with the aid of the spline, the assembly of the hybrid drive module can be simplified. In addition, due to the torsional vibration damper connected upstream, the service life of the spline is also improved.

According to one alternative example embodiment, the hub includes a torque-transmitting interface to a first half of an offset compensation element. A second half of the offset compensation element is connectable, in a torque-transmitting manner, to the crankshaft of the internal combustion engine, if necessary via an intermediate element. The offset compensation element is configured for compensating for a radial offset between the axes of rotation of the two halves of the offset compensation element as well as for an axial offset between the two halves. Due to the utilization of such an offset compensation element, the mounting and support of the composite of hub, torque converter, and rotor carrier is decoupled from the crankshaft. This further reduces the susceptibility of the hybrid drive module to vibrations.

Preferably, the first half of the offset compensation element includes a tooth system on one face end. This tooth system is in engagement with a tooth system, which is formed on a face end of the hub, so that the first half of the offset compensation element is connected to the hub in a torque-transmitting manner. Such a pairing of tooth systems is also referred to as Hirth toothing, and allows for a reliable centering between the components connected to the tooth system. Preferably, the tooth system between the hub and the offset compensation element is preloaded with the aid of a screw. As a result, the torque transmission capacity of the tooth system can be increased.

Preferably, the second half of the offset compensation element is connectable to the crankshaft of the internal combustion engine via a flexplate. A flexplate is understood to be, in this case, a plate-like, torque-transmitting device, which is flexible enough to compensate for slight malpositions of the components to be connected.

The offset compensation element can be formed by a composite, which includes a torsional vibration damper and a centrifugal pendulum absorber. In addition damping torsional vibrations, the torsional vibration damper is configured for compensating for a radial offset. In addition to at least partially absorbing torsional vibrations, the centrifugal pendulum absorber is configured for compensating for an axial offset. In the case of such an example embodiment of the offset compensation element, the torque-transmitting interface of the offset compensation element to the hub can be designed as a spline. Preferably, the centrifugal pendulum absorber is arranged between the torsional vibration damper and the hub.

According to one preferred example embodiment, the rotor carrier is screwed, riveted, or welded to the hub. Such a split design of the composite of hub and rotor carrier facilitates the mechanical machining of the bearing seat at the hub.

According to one preferred example embodiment, the converter housing is rotatably supported via a second bearing on a second bearing shield of the hybrid drive module. The second bearing is preferably located at an axial end of the torque converter, which is positioned opposite the hub. As a result, a particularly wide bearing base of the composite of torque converter, hub, and rotor carrier, including rotor, can be achieved.

Preferably, the stator is directly attached to the bearing shield. Since the rotor is supported via the rotor carrier, the hub, and the first bearing against the same bearing shield, a short tolerance chain between the rotor and the stator results. As a result, the air gap between the rotor and the stator is particularly precisely adjustable, and is subject to only low tolerances.

According to one preferred example embodiment, a clutch is arranged within the converter housing, wherein, by engaging this clutch, the converter housing is connectable to a turbine wheel of the torque converter. Since an impeller of the torque converter is usually rotationally fixed to the converter housing, the engagement of this clutch results in a lock-up of the torque converter. Moreover, a torsional vibration damper is arranged within the converter housing, which operates between the clutch and an output hub of the torque converter connected to the turbine wheel. Due to such an example embodiment, torsional vibrations occurring at the hub when the clutch is engaged can be reduced. Preferably, a centrifugal pendulum absorber is also provided, which is arranged within the converter housing and operates between the turbine wheel and the output hub of the torque converter. Due to such an arrangement, torsional vibrations at the output hub can be further reduced, in particular in the effective range of the centrifugal pendulum absorber. Additionally, a further torsional vibration damper can be provided, which is arranged within the converter housing and operates between the clutch and the centrifugal pendulum absorber. Such an arrangement also reduces the torsional vibrations occurring at the output hub.

According to one alternative possible example embodiment, a clutch and a centrifugal pendulum absorber are arranged within the converter housing. The converter housing is connectable to a turbine wheel of the torque converter by engaging the clutch. The centrifugal pendulum absorber is connected to the inner side of the converter housing. Preferably, this example embodiment does not include a torsional vibration damper arranged within the converter housing.

Preferably, the hybrid drive module is an integral part of a motor vehicle automatic transmission. The torque converter acts as a starting component of a motor vehicle equipped with the automatic transmission. The one-part or multiple-part housing of the hybrid drive module accommodates planetary gear sets and shift elements, with the aid of which a plurality of gears is implementable between an input shaft and an output shaft of the automatic transmission. The input shaft is connected to the output hub of the torque converter.

Alternatively, the hybrid drive module can be designed as an independent unit including an interface to a motor vehicle automatic transmission. The hybrid drive module is detachable from the automatic transmission.

The hybrid drive module can be an integral part of a drive train of a motor vehicle. The electric machine of the hybrid drive module can be provided for driving the motor vehicle and/or for starting an internal combustion engine of the drive train.

### BRIEF DESCRIPTION OF THE DRAWINGS

Exemplary embodiments of the invention are described in detail in the following with reference to the attached figures. Wherein:

FIG. 1 through FIG. 5 each show an exemplary embodiment of a hybrid drive module; and

FIG. 6 and FIG. 7 each show a drive train of a motor vehicle.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

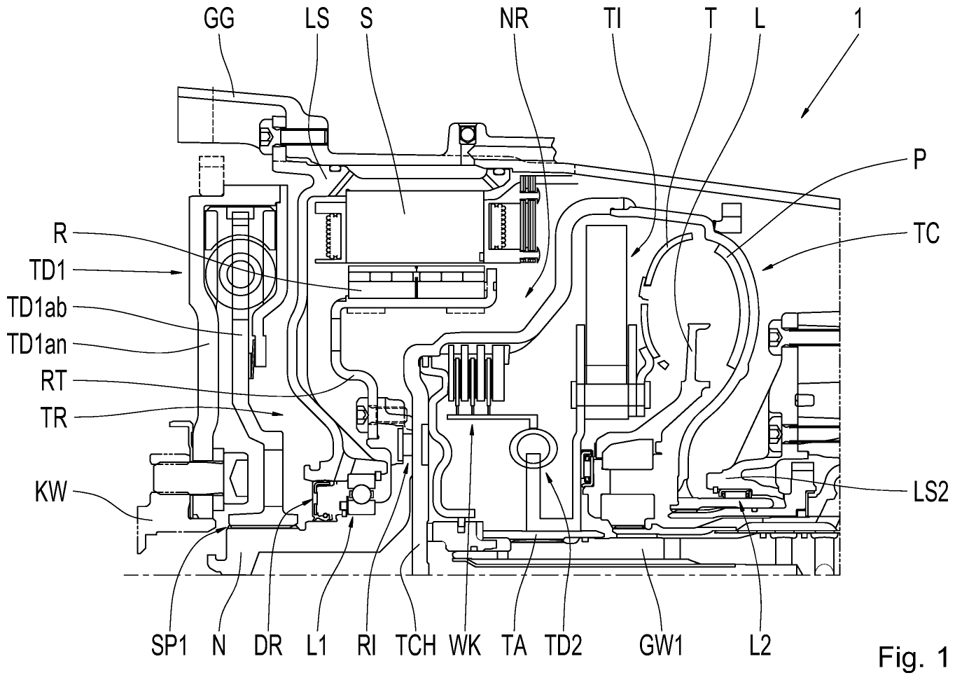

FIG. 1 shows a hybrid drive module 1 according to a first exemplary embodiment. The hybrid drive module 1 includes a housing GG, within which an electric machine is arranged; the electric machine includes a stator S, which is rotationally fixed with respect to the housing GG, and a rotary rotor R. The hybrid drive module 1 includes a torque converter TC. An impeller P of the torque converter TC is fixedly connected to a converter housing TCH of the torque converter TC. A stator L of the torque converter TC is held against rotating in one direction of rotation via a freewheel unit. A turbine wheel T of the torque converter TC is connected via a centrifugal pendulum absorber TI to an output hub TA of the torque converter TC. The output hub TA is connected to an input shaft GW1 of an automatic transmission (not represented in greater detail). Moreover, a clutch WK is arranged within the converter housing TCH. By engaging the clutch WK, the converter housing TCH is connectable to one half of a torsional vibration damper TD2. Another half of the torsional vibration damper TD2 is connected to the output hub TA.

The rotor R of the electric machine is arranged on a rotor carrier RT, which is fixedly connected to a hub N via a screw connection. The hub N is rotatably supported via an inner ring of a first bearing L1. The first bearing L1 is designed as a single-row grooved ball bearing and is configured for supporting the hub N in the radial direction as well as in the axial direction. An outer ring of the first bearing L1 is supported against a bearing shield LS. The bearing shield LS is attached to the housing GG and is also utilized for the direct attachment of the stator S of the electric machine. The bearing shield LS therefore acts as a stator carrier.

The bearing shield LS separates a wet space NR of the hybrid drive module 1 from a dry space TR. The seal of the wet space NR with respect to the dry space TR takes place with the aid of a sealing ring DR, which is arranged directly next to the first bearing L1.

The hub N includes a torque-transmitting interface SP1 to a secondary side TD1ab of a torsional vibration damper TD1. The interface SP1 as well as the torsional vibration damper TD1 are arranged in the dry space TR of the hybrid drive module 1. The interface SP1 is designed as a spline. A primary side TD1an of the torsional vibration damper TD1 is connectable via a screw connection to a crankshaft KW of an internal combustion engine (not represented in greater detail). The internal combustion engine is not an integral part of the hybrid drive module 1. In addition to damping torsional vibrations, the torsional vibration damper TD1 is also configured for compensating for a radial offset of the axes of rotation of the primary side TD1an and the secondary side TD1ab.

The hub N is rotationally fixed to the converter housing TCH of the torque converter TC via a rivet joint RI. The rivet joint is designed as a self-piercing rivet joint, so that no through-bores in the converter housing TCH are necessary. Due to the rivet joint RI, it is ensured that the composite of hub N, rotor carrier RT, rotor R, and converter housing TCH have the same axis of rotation. This composite is supported via the first bearing L1 and a second bearing L2. The second bearing L2 is supported against a second bearing shield LS2 of the hybrid drive module 1. The second bearing L2 is designed as a needle bearing. The second bearing shield LS2 is connected to the housing GG. The support of the stator L also takes place via the second bearing shield LS2.

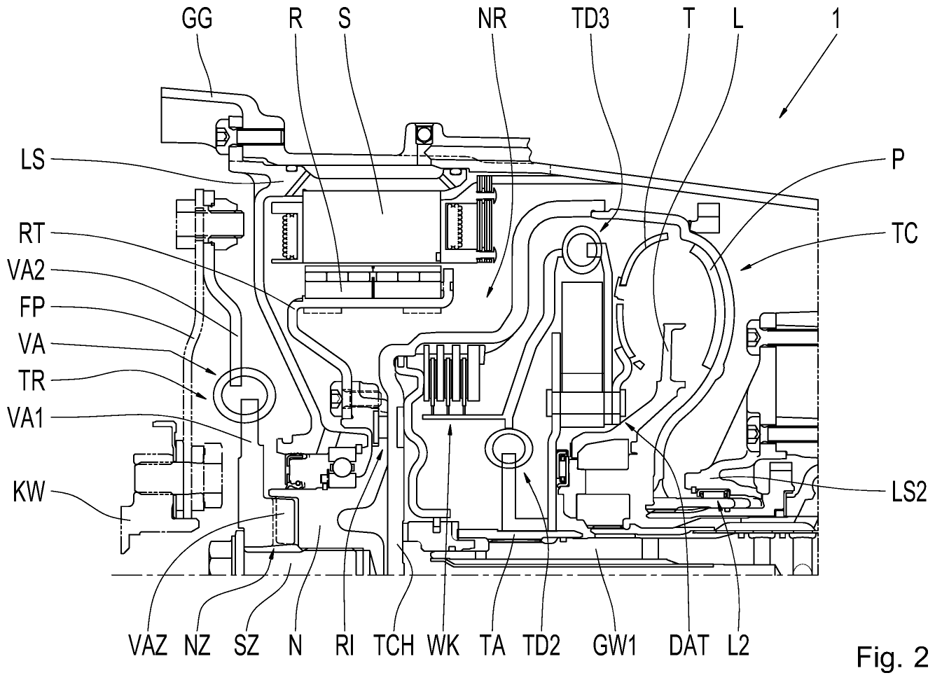

FIG. 2 shows a hybrid drive module 1 according to a second exemplary embodiment, which essentially corresponds to the first exemplary embodiment represented in FIG. 1. The torsional vibration damper TD1 was replaced by an offset compensation element VA, which includes a first half VA1 and a second half VA2. The offset compensation element VA is configured for compensating for a radial offset as well as for an axial offset between the two halves VA1, VA2. The first half VA1 is connected to the hub N. For this purpose, the hub N includes a torque-transmitting interface, which is designed as a tooth system NZ. The tooth system NZ is located on a face end (or end face) of the hub N. A tooth system VAZ, which is in engagement with the tooth system NZ, is formed on the first half VA1. The tooth system pair axially aligned in such a way is utilized for transmitting torque from the first half VA1 to the hub N and for centering these two components. The second half VA2 is connectable to a crankshaft KW via a flexplate FP. For this purpose, the second half VA2 is connected via a screw connection to the flexplate FP, which is connected to the crankshaft KW via a further screw connection.

The hybrid drive module 1 according to the second exemplary embodiment also differs from the first exemplary embodiment represented in FIG. 1 by one further torsional vibration damper TD3. The torsional vibration damper TD3 is arranged within the converter housing TCH, between the clutch WK and the centrifugal pendulum absorber TI.

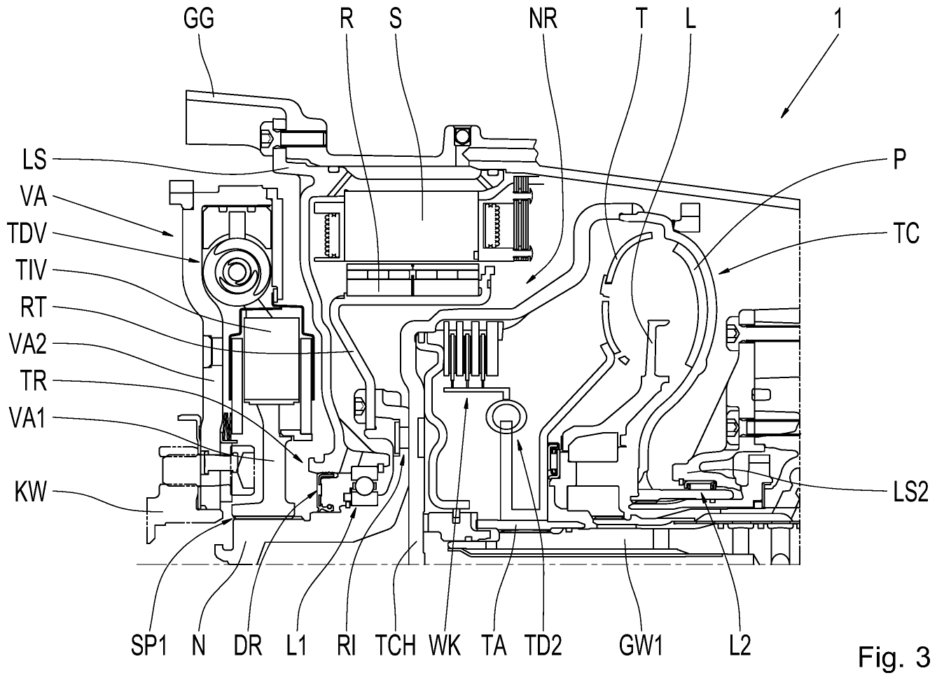

FIG. 3 shows a hybrid drive module 1 according to a third exemplary embodiment, which essentially corresponds to the first exemplary embodiment represented in FIG. 1. The torsional vibration damper TD1 was replaced by an offset compensation element VA, which includes a first half VA1 and a second half VA2. The offset compensation element VA includes a torsional vibration damper TDV and a centrifugal pendulum absorber TIV. The centrifugal pendulum absorber TIV is arranged between the torsional vibration damper TDV and the hub N, wherein the torque transmission between the torsional vibration damper TDV and the hub N takes place via an interface SP1. The interface SP1 is designed as a spline.

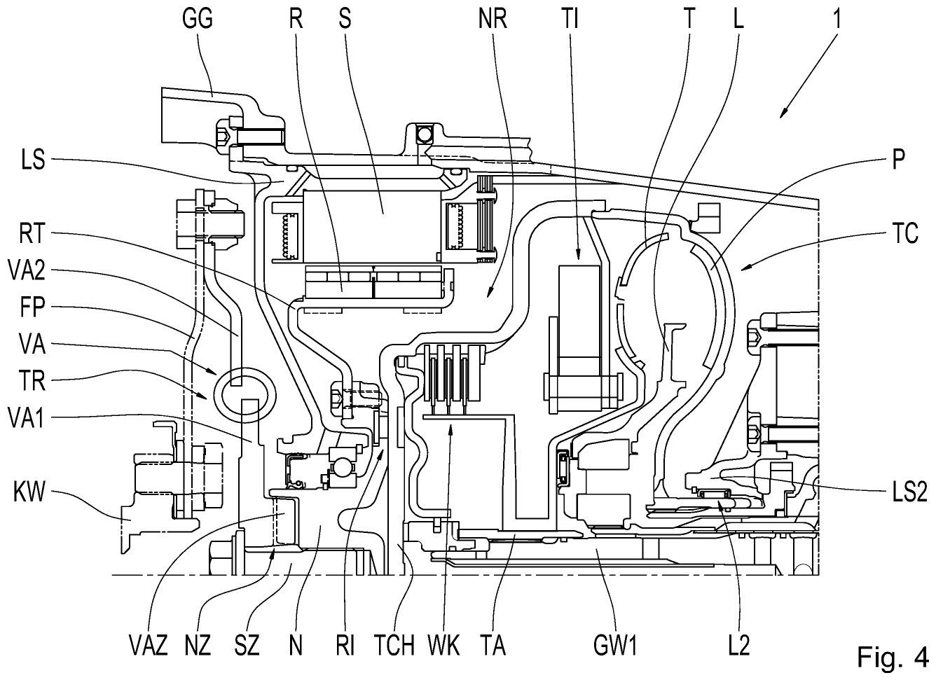

FIG. 4 shows a hybrid drive module 1 according to a fourth exemplary embodiment, which essentially corresponds to the first exemplary embodiment represented in FIG. 1. In this hybrid drive module 1, no torsional vibration damper is arranged within the converter housing TCH; the torsional vibration dampers TD2, TD3 contained in the exemplary embodiment according to FIG. 2 are therefore omitted. The clutch WK is now directly connected to the output hub TA via the inner disk carrier of the output hub TA. The centrifugal pendulum absorber TI is now connected to the converter housing TCH, in particular in the area of the butt between the converter housing shell and the impeller shell. The connection of the centrifugal pendulum absorber to the turbine wheel T is therefore omitted.

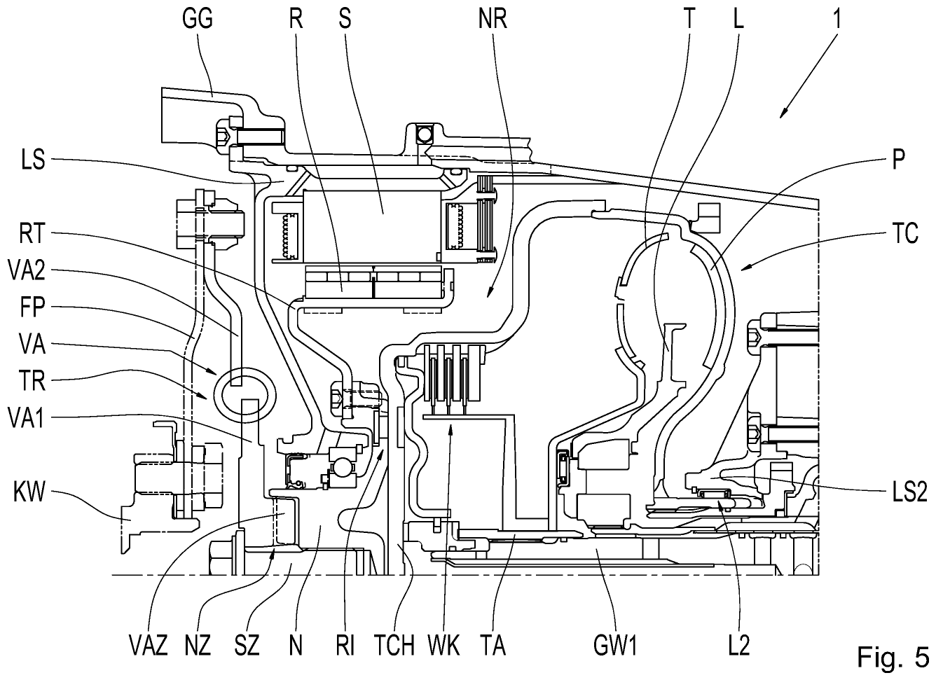

FIG. 5 shows a hybrid drive module 1 according to a fifth exemplary embodiment, which essentially corresponds to the fourth exemplary embodiment represented in FIG. 4. In this hybrid drive module 1, no centrifugal pendulum absorber TI is arranged within the converter housing TCH.

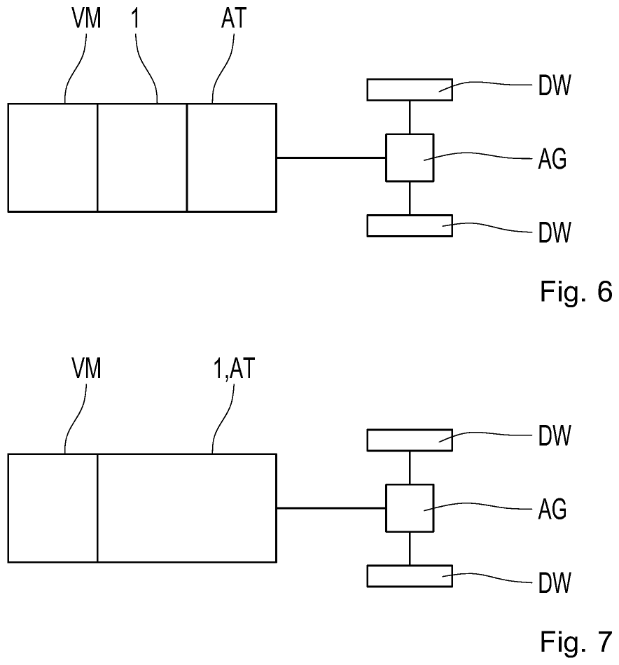

FIG. 6 shows a drive train of a motor vehicle. The drive train includes an internal combustion engine VM, the hybrid drive module 1, as well as an automatic transmission AT. The hybrid drive module 1 and the automatic transmission AT are units, separated from one another, including at least one interface, via which the hybrid drive module 1 and the automatic transmission AT are connectable to each other. A hydraulic supply of the hybrid drive module 1 preferably takes place via a hydraulic system of the automatic transmission AT. On the output end, the automatic transmission AT is connected to a differential gear AG, for example, via a drive or cardan shaft. The power present at an output shaft of the automatic transmission AT is distributed to driving wheels DW of the motor vehicle with the aid of the differential gear AG.

FIG. 7 shows a drive train of a motor vehicle, which essentially corresponds to the drive train represented in FIG. 6. The hybrid drive module 1 and the automatic transmission AT form one common component in this case. In other words, the hybrid drive module 1 is an integral part of the automatic transmission AT.

The drive trains represented in FIG. 6 and FIG. 7 are to be considered merely as examples. Instead of the represented design including a drive train aligned longitudinally with respect to the direction of travel of the motor vehicle, a use in a drive train aligned transversely to the direction of travel is also conceivable. The differential gear AG can be integrated into the transmission G. The drive train including the hybrid drive module 1 is also suitable for an all-wheel application.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

1 hybrid drive module
GG housing
S stator
R rotor
RT rotor carrier
NR wet space
TR dry space
DR sealing ring
N hub
NZ tooth system
SP1 interface
L1 first bearing
LS bearing shield
L2 second bearing
LS second bearing shield
TC torque converter
TCH converter housing
P impeller
L stator
T turbine wheel
WK clutch
TI centrifugal pendulum absorber
TD3 torsional vibration damper
RI rivet joint
TD1 torsional vibration damper
TD1an primary side
TD1ab secondary side
KW crankshaft
VM internal combustion engine
VA offset compensation element
VA1 first half
VA2 second half
VAZ tooth system
SZ screw
FP flexplate
TDV torsional vibration damper
TIV centrifugal pendulum absorber
AT automatic transmission
GW1 input shaft
AG differential gear
DW driving wheel

1-18: (canceled)

19. A hybrid drive module (1) for a motor vehicle, comprising:
a housing (GG);
an electric machine with a rotary rotor (R) and a stator (S), the stator (S) rotationally fixed relative to the housing (GG); and
a torque converter (TC),
wherein the rotor (R) is arranged on a rotor carrier (RT), and the rotor carrier (RT) is fixedly connected to a hub (N),
wherein the hub (N) is rotatably supported by a first bearing (L1) in a radial direction and an axial direction against a bearing shield (LS) attached to the housing (GG),
wherein the hub (N) is rotationally fixed to a converter housing (TCH) of the torque converter (TC) with a rivet joint (RI) or a screw connection.

20. The hybrid drive module (1) of claim 19, wherein the hub (N) comprises a torque-transmitting interface (SP1) to a secondary side (TD1ab) of a torsional vibration damper (TD1), a primary side (TD1an) of the torsional vibration damper (TD1) connectable to a crankshaft (KW) of an internal combustion engine in a torque-transmitting manner such that a radial offset between an axis of rotation of the crankshaft (KW) and an axis of rotation the rotor (R) and the converter housing (TCH) connected to the rotor (R) is compensated for by the torsional vibration damper (TD1).

21. The hybrid drive module (1) of claim 19, wherein the hub (N) comprises a torque-transmitting interface to a first half (VA1) of an offset compensation element (VA), a second half (VA2) of the offset compensation element (VA) is connectable to a crankshaft (KW) of an internal combustion engine in a torque-transmitting manner, and the offset compensation element (VA) is configured for compensating for a radial offset and an axial offset between the first and second halves (VA1, VA2).

22. The hybrid drive module (1) of claim 21, wherein the first half (VA1) of the offset compensation element (VA) comprises a tooth system (VAZ) on an end face of the first half (VA1) of the offset compensation element (VA), the tooth system (VAZ) engaging with a tooth system (NZ) formed on an end face of the hub (N) such that the first half (VA1) of the offset compensation element (VA) is connected to the hub (N) in a torque-transmitting manner.

23. The hybrid drive module (1) of claim 22, wherein the tooth system (VAZ, NZ) between the hub (N) and the first half (VA1) of the offset compensation element (VA) is preloaded by a screw (SZ).

24. The hybrid drive module (1) of claim 21, wherein the second half (VA2) of the offset compensation element (VA) is connectable to the crankshaft (KW) with a flexplate (FP).

25. The hybrid drive module (1) of claim 21, wherein the offset compensation element (VA) is formed by a composite part that comprises a torsional vibration damper (TDV) and a centrifugal pendulum absorber (TIV).

26. The hybrid drive module (1) of claim 25, wherein the centrifugal pendulum absorber (TIV) is arranged between the torsional vibration damper (TDV) and the hub (N).

27. The hybrid drive module (1) of claim 19, wherein the rotor carrier (RT) is screwed, riveted, or welded to the hub (N).

28. The hybrid drive module (1) of claim 19, wherein the converter housing (TCH) is supported by a second bearing (L2) against a second bearing shield (LS2) of the hybrid drive module (1).

29. The hybrid drive module (1) of claim 19, wherein the stator (S) is directly attached to the bearing shield (LS).

30. The hybrid drive module (1) of claim 19, further comprising a clutch (WK) and a torsional vibration damper (TD2), the clutch (WK) arranged within the converter housing (TCH), the converter housing (TCH) connectable to a turbine wheel (T) of the torque converter (TC) by engaging the clutch (WK), the torsional vibration damper (TD2) arranged within the converter housing (TCH) between the clutch (WK) and an output hub (TA) of the torque converter (TC) connected to the turbine wheel (T).

31. The hybrid drive module (1) of claim 30, further comprising a centrifugal pendulum absorber (TI) arranged within the converter housing (TCH) between the clutch (WK) and the turbine wheel (T).

32. The hybrid drive module (1) of claim 31, further comprising a further torsional vibration damper (TD3) arranged within the converter housing (TCH) between the clutch (WK) and the centrifugal pendulum absorber (TI).

33. The hybrid drive module (1) of claim 31, further comprising a clutch (WK) and a centrifugal pendulum absorber (TI), the clutch (WK) arranged within the converter housing (TCH), the converter housing (TCH) connectable to a turbine wheel (T) of the torque converter (TC) by engaging the clutch (WK), the centrifugal pendulum absorber (TI) arranged at the converter housing (TCH).

34. The hybrid drive module (1) of claim 33, wherein no torsional vibration damper is arranged within the converter housing (TCH).

35. The hybrid drive module (1) of claim 31, wherein the hybrid drive module (1) is either an integral part of a motor vehicle automatic transmission (AT) or is an independent unit comprising at least one interface to the motor vehicle automatic transmission (AT).

36. A drive train for a motor vehicle, comprising the hybrid drive module (1) of claim 19.
